(19) United States
(12) Patent Application Publication
(10) Pub. No.: US 2026/0095753 A1
(43) Pub. Date: Apr. 2, 2026

(54) TECHNIQUES FOR PROVIDING LOCAL ACCESS TO REMOTE ENVIRONMENTS IN CELLULAR NETWORKS

(71) Applicant: T-Mobile USA, Inc., Bellevue, WA (US)

(72) Inventor: Henry Cyril, Bothell, WA (US)

(21) Appl. No.: 18/902,758

(22) Filed: Sep. 30, 2024

(51) Int. Cl. H04W 8/22

(52) U.S. Cl. CPC H04W 8/22

(57) ABSTRACT

Techniques are described for providing user equipment operating in a first environment with controlled access to a second environment. The techniques may be performed by an access node implemented in the first environment and may comprise receiving an indication that a second environment is accessible, receiving a communication that originates from a user equipment, determining, based on information about the communication, whether one or more conditions are met. The techniques may further involve upon determining that the one or more conditions are not met, routing the communication to a first core node implemented within the first environment, and upon determining that the one or more conditions are met, routing the communication to a second core node implemented within the second environment, wherein the user equipment is caused to operate in the first environment using one or more operating parameters associated with the second environment.

### BACKGROUND

Currently, cellular technology has advanced to its fifth generation (5G). Cellular networks are frequently used to enable communication between various mobile devices. In a cellular network (such as the Global System for Mobile communication (GSM) and TETRA (TErrestrial Trunked RAdio)), a geographical region is divided into a number of cells, each of which is served by a base station (also referred to as a Base Transceiver Station (BTS)). Such cellular networks are typically made up of a number of base stations that are geographically distributed throughout the geographical region in a way that maximizes wireless transmission coverage for the cellular network.

When new features and/or functionality are introduced into cellular networks, those features must first be tested in order to ensure that they will not cause major issues with operations of the cellular network. Notably, specifications for the cellular network may vary by region and so testing in one region may not be sufficient to show that operations will not be impacted within a different region. However, it may be difficult to implement separate testing environments in each region within which such testing should be conducted.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 is a block diagram that illustrates a wireless telecommunication network architecture in which aspects of the disclosed technology may be implemented in accordance with embodiments;

FIG. 2 depicts a component diagram of an example system that may be implemented in a network in order to enable access across environments in accordance with at least some embodiments;

FIG. 3 depicts a block diagram illustrating a first set of interactions between multiple environments in accordance with at least some embodiments;

FIG. 4 depicts a block diagram illustrating a second set of interactions between multiple environments in accordance with at least some embodiments;

FIG. 5 depicts a block diagram illustrating a third set of interactions between multiple environments in accordance with at least some embodiments;

FIG. 6 depicts a block diagram illustrating a process for routing communications to various core nodes in accordance with embodiments;

FIG. 7 depicts a block diagram illustrating a process for rejecting incorrectly received communications in accordance with embodiments;

FIG. 8 depicts a flow diagram illustrating an exemplary process for generating tag assignment data to be used in network traffic allocation in accordance with at least some embodiments;

FIG. 9 shows an example computer architecture for a computing device 900 capable of executing program components for implementing the functionality described above.

### DETAILED DESCRIPTION

This disclosure describes techniques that may be performed to enable user equipment operating in a first environment to access operating parameters/services that are implemented on a second (e.g., segregated) environment. In embodiments, communications received from user equipment operating in the first environment is received at a node device (e.g., an access node) that makes a determination as to which of multiple core nodes that communication is to be routed. Such determinations may be made based on a unique identifier for the user equipment on which the communication originated and/or various conditions under which the communication was received.

An environment, for the purposes of this disclosure, may include any set of computing devices/components that allow a network to operate and/or provide services. Note that network environments may be segregated geographically, by user equipment type, by protocol, etc.

Provided that an access node makes a determination that a particular communication meets each of the conditions necessary to access a core node within the second environment, a communication session is established between the user equipment and that core node such that the user equipment is able to operate on a first environment while accessing operation parameters implemented within a second environments.

Embodiments of the disclosure provide for a number of advantages over conventional systems. For example, embodiments of the disclosure enable controlled access to a segregated environment (e.g., a test environment) through an open environment (e.g., a production environment). This allows users located within a geographic region associated with the open environment to test updates implemented within the segregated environment while preventing/limiting exposure of other users to any critical vulnerabilities introduced by the updates.

When new updates are to be implemented within a network, those updates are typically not provided to a production cell service (CS) node or a production PCRF node until they have been thoroughly tested. Such testing is typically performed within a test environment. However, due to the wide variance of operating parameters and/or available services across environments, such testing is often insufficient as it might prove extremely costly to perform testing under all possible combinations of operating parameters and/or available services. However, testing cannot typically be performed within the production environment as implementing an update for testing within that environment can expose user equipment operating in the environment to potential harm.

Embodiments of the disclosure provide for functionality by which one or more user equipment are able to access a segregated first environment on a selective basis through a second environment. This allows updates implemented in the first environment to be selectively accessed in the second environment, such as for testing purposes.

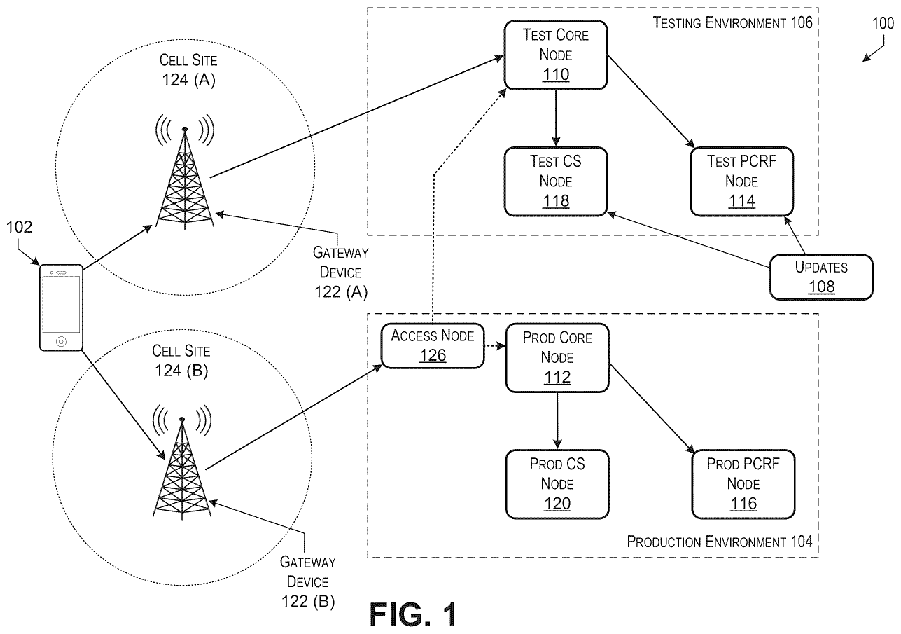

FIG. 1 is a block diagram that illustrates a wireless telecommunication network architecture 100 in which aspects of the disclosed technology may be implemented in accordance with embodiments. The architecture 100 includes at least one user equipment 102 that is capable of communicating with one or more networks via respective access points.

In embodiments, a network (e.g., a cellular network) may include multiple environments, some of which may be segregated and/or inaccessible to other environments. For example, a network may include a production environment 104 that is implemented across a geographic region. In this example, that same network may include a testing environment 106 within which one or more updates 108 can be implemented without impacting the production environment 104.

As depicted, an environment may include a number of components that each perform a set of functionalities within the environment. In some cases, each environment may include a node for performing core functions (e.g., a core node) such as test core node 110 of the testing environment 106 or a production access node 126 of the production environment 104. Additionally, each environment may include a node for performing a Policy and Charging Rules Function (PCRF), such as test PCRF node 114 of the testing environment 106 or a production PCRF node of the production environment 104. For the purposes of this disclosure, a PCRF node is a software node designated in real-time to determine policy rules in a multimedia network. Additionally, each environment may include a CS node for performing the functions needed to support users, administrators, and applications running on compute nodes, such as test CS node 118 of the testing environment 106 or a production CS node 120 of the production environment 104.

Each environment may be accessed by a user equipment 102 via a gateway device 122 (e.g., gateway device 122 (a) or (b)) associated with the environment. Generally, a gateway device 122 may provide the user equipment 102 with ingress/egress to a network that includes an environment. In some cases, one or more user equipment 102 may be configured to operate using a variety of network protocols on various types of networks.

A gateway device 122 may be any suitable electronic device that is capable of managing access to one or more networks. In some embodiments, the gateway device 122 may be, or may be implemented within, a base station. A base station is a type of network access node (NAN) that can also be referred to as a cell site (e.g., cell site 124 (A) or (B)), a base transceiver station, or a radio base station. In some embodiments, the gateway device 122 may include one or more radio access units that provide service (e.g., cellular data service) to a user equipment 102 within a geographic area surrounding the gateway device 122 (e.g., a cell). The network architecture 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point. In some embodiments, a group of neighboring base stations/gateway devices 122 may be managed by a base station controller (not shown).

A gateway device 122 implemented as a base station may include one or more transmission mechanisms (e.g., a radio transceiver) capable of enabling wireless communication with a number of user equipment. Such base stations may be distributed over an area in a sufficiently dense manner such that multiple user equipment (e.g., mobile communication devices) in communication with the network can communicate with each other or with a terrestrial network. In some embodiments, the gateway device 122 may include one or more sensors configured to collect information about the gateway device 122 itself or an environment in which the gateway device 122 is situated. Additionally, the gateway device 122 may include one or more mechanical means of adjusting/configuring components of the equipment node. For example, the equipment node may include a radio antenna as well as a motorized mechanism for adjusting a position of the radio antenna.

A gateway device 122 implemented as a base station can wirelessly communicate with multiple user equipment 102 within wireless communication range via one or more base station antennas. The architecture 100 can include base stations of different types (e.g., macro and/or small cell base stations). In some implementations, there can be overlapping geographic coverage areas (e.g., cells) for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.). In some embodiments, the network may operate using a fixed wireless access (FWA) connection. FWA is a type of wireless technology, e.g., 5G or 4G LTE wireless technology, that enables fixed broadband access using radio frequencies rather than cables.

The user equipment 102 can correspond to or include devices capable of communication using various connectivity standards. For example, a 5G communication channel can use millimeter wave (mmW) access frequencies of 28 GHz or more. In some implementations, a user equipment 102 can operatively couple to a gateway device 122 over a long-term evolution/long-term evolution-advanced (LTE/LTE-A) communication channel, which is referred to as a 4G communication channel. In some non-limiting examples, user equipment can include handheld mobile devices (e.g., smartphones, portable hotspots, tablets, etc.); laptop devices; wearable devices; drones; vehicles with wireless connectivity; head-mounted displays with wireless augmented reality/virtual reality (AR/VR) connectivity; portable gaming consoles; wireless routers, gateways, modems, and other fixed-wireless access devices; wirelessly connected sensors that provides data to a remote server over a network; IoT devices such as wirelessly connected smart home appliances, etc.

A user equipment 102 can communicate with various types of access points and network equipment at the edge of a network including macro eNBs/gNBs, small cell eNBs/gNBs, relay base stations, and the like. A user equipment can also communicate with other user equipment either within or outside the same coverage area of a base station via device-to-device (D2D) communications.

A communication link between a user equipment 102 and a gateway device 122 may include uplink (UL) transmissions from a user equipment 102 to a gateway device 122, and/or downlink (DL) transmissions from a gateway device 122 to a user equipment 102. The downlink transmissions can also be called forward link transmissions while the uplink transmissions can also be called reverse link transmissions. Each communication link includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links can transmit bidirectional communications using frequency division duplex (FDD) (e.g., using paired spectrum resources) or Time division duplex (TDD) operation (e.g., using unpaired spectrum resources). In some implementations, the communication links include LTE and/or mmW communication links.

The network architecture 100 can include a 5G network and/or an LTE/LTE-A or other network. In an LTE/LTE-A network, the term eNB may be used to describe the gateway devices 122 used in 5G new radio (NR) networks, the term gNBs may be used to describe the gateway devices 122 that can include mmW communications. The network architecture 100 can thus form a heterogeneous network in which different types of base stations provide coverage for various geographic regions. For example, each gateway device 122 can provide communication coverage for a local network that forms a macro cell, a small cell, and/or other types of cell sites. As used herein, the term “cell site” or “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by user equipment that have service subscriptions with a wireless network service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by user equipment that have service subscriptions with the network provider of architecture 100. A femto cell covers a relatively smaller geographic area (e.g., a home) and can provide restricted access by user equipment having an association with the femto unit (e.g., user equipment in a closed subscriber group (CSG), user equipment for users in the home). A base station can support one or multiple (e.g., two, three, four, and the like) cells (e.g., component carriers). All fixed transceivers noted herein that can provide access to the network are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a user equipment 102 and the gateway devices 122 or core network supporting radio bearers for the user plane data. At the Physical (PHY) layer, the transport channels are mapped to physical channels.

In operation, a user equipment 102 can connect to one of the environments (e.g., testing environment 106 or production environment 104) over a connection to a respective gateway device 122 (e.g., gateway device 122 (A) or (B)). The gateway device 122 connects to the core node (e.g., 110 or 112) of the environment to which the user equipment 102 is to be connected. The core node of the environment may then retrieve information about operating parameters and/or available services for that environment from other nodes, such as the respective CS node (e.g., 118 or 120) or the respective PCRF node (e.g., 114 or 116). It should be noted that operating parameters and/or available services may vary greatly across different regions/environments.

It should be noted that a user equipment 102 may not be capable of operating in multiple environments simultaneously. Hence, updates 108 that are introduced to one environment (e.g., testing environment 106) may not be made available to a user equipment 102 that is accessing a different environment. In some cases, an environment, such as the testing environment 106, mat be geographically segregated from one or more other environments. In such cases, the user equipment 102 may typically need to be in communication range of the gateway device 122 associated with that environment in order to access it.

In embodiments, a core node of an environment may be configured to allow for a user equipment 102 operating in that environment to access one or more nodes from a different environment. For example, the production access node 126 may be configured to selectively allow access to nodes within a different environment via an access node 126. In embodiments, the access node 126 allows selective user equipment to access updates and other data stored in one environment while implementing operating parameters and/or available services from another. The access node 126 may manage access between environments based on a user equipment being in an allowed list of user equipment and/or access being attempted within a predetermined time period.

The illustrative network architecture 100 may incorporate, by way of example, CDMA2000 based mobile wireless network components (e.g., AAA service for performing user authentication and providing user profiles) and includes data services delivered via one or more data access protocols, such as EV-DO, EV-DV or the like. Other embodiments include a wireless access network complying with one or more of LTE, WCDMA, UMTS, GSM, GPRS, EDGE, Wi-Fi (i.e., IEEE 802.11x), Wi-MAX (i.e., IEEE 802.16), or similar telecommunication standards configured to deliver voice and data services to mobile wireless end user equipment such as, a user equipment 102 depicted in FIG. 1 carrying out wireless communications via a gateway device 122. Such a mobile wireless network system may include hundreds or thousands of such base stations.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

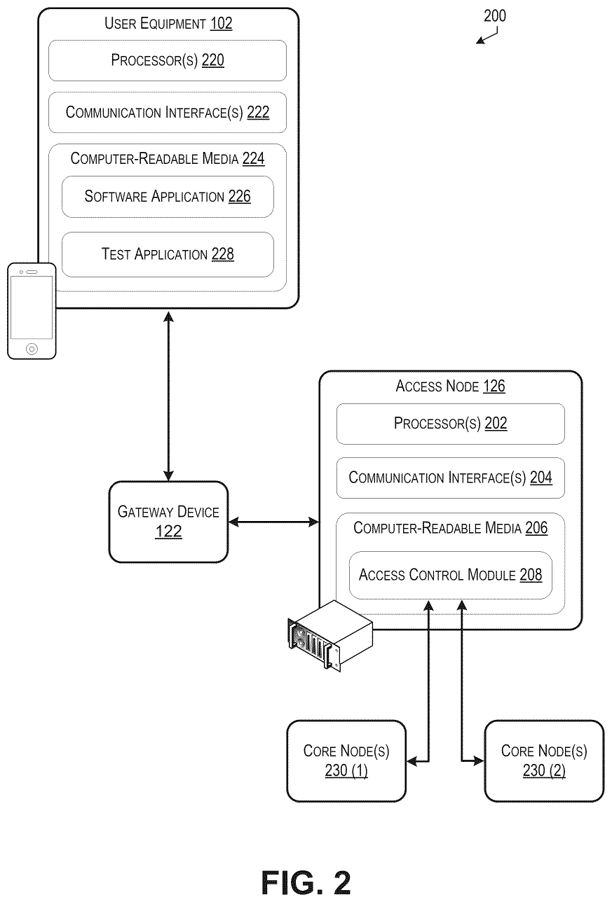

FIG. 2 depicts a component diagram of an example system that may be implemented in a network (e.g., a mobile network) in order to enable access across environments in accordance with at least some embodiments. As depicted in FIG. 2, a gateway device 122 is in wireless communication with a user equipment 102 operated by a user. Additionally, as described elsewhere, the gateway device 122 may be further in communication with one or more access node 126 and/or an external network.

In some embodiments, gateway device 122 may be an example of the gateway device 122 as described in relation to FIG. 1 above. In some embodiments, the gateway device 122 is implemented on, or in direct communication with, a base station. It should be noted that such an access point (or any other described computing component) may include a single computing device (e.g., a server device) or a combination of computing devices. In some cases, the access point may be implemented as a virtual device/system (e.g., via virtual machines implemented within a cloud computing environment).

As illustrated, the access node 126 may include one or more hardware processors 202 configured to execute one or more stored instructions. Such processor(s) 202 may comprise one or more processing cores. Further, the access node 126 may include one or more communication interfaces 204 configured to provide communications between the access node 126 and other devices, such as the user equipment 102 or any other suitable electronic device.

The access node 126 may also include computer-readable media 206 that stores various executable components (e.g., software-based components, firmware-based components, etc.). The computer-readable media 206 may store components to implement functionality described herein. While not illustrated, the computer-readable media 206 may store one or more operating systems utilized to control the operation of the one or more devices that comprise the access node 126. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 206 may include portions, or components, that configure the access node 126 to perform various operations described herein. For example, the computer-readable media 206 may include some combination of components configured to implement the described techniques. Particularly, the access node 126 may include a component configured to allocate network traffic to an appropriate node/environment (e.g., access control module 208). Additionally, the computer-readable media 206 may further maintain one or more databases, such as a database of information maintained in relation to mappings of user equipment and respective environments.

An access control module 208 may be configured to, when executed by the processors 202, make a determination about a core node 230 (e.g., core node 230 (1) or 230 (2)) to which communications from a user equipment 102 should be directed. In embodiments, each of the core nodes 230 (1 and 2) may be implemented within different environments. For example, a core node 230 (1) may be implemented within an environment in which the access node 126 is also implemented while a core node 230 (2) may be implemented within a different environment.

As noted elsewhere, a core node 230 may be a computing device configured to perform the functions needed to support users, administrators, and applications. By allocating network traffic received from a user equipment 102 within a first environment to a core node implemented within a second (different) environment. This allows a user equipment to implement services in a first environment using operating parameters associated with a different environment.

The access control module 208 may make determinations about which core node 230 communications from a user equipment are to be routed to based on information about the user equipment and/or compliance with various access requirements. By way of a first example, a list of unique identifiers associated with user equipment authorized to access an environment may be maintained. In such cases, communications from user equipment determined to be authorized to access an environment may be routed to the core node 230 within that environment whereas communications from user equipment not determined to be authorized to access the environment may be routed to the core node 230 within a current environment instead. A unique identifier associated with a user equipment may be a serial number, an International Mobile Equipment Identity (IMEI) number, a Mobile Station International Subscriber Directory Number (MSISDN), or any other suitable string of characters capable of uniquely identifying a user equipment.

In some cases, access to a particular environment may be limited to scenarios in which certain conditions have been met. For example, upon receiving a communication from a user equipment (and provided that a determination is made that the user equipment is authorized to access an environment), the access control module 208 may route the communication to an environment only if the prerequisite conditions are met. In this example, the prerequisite conditions may include the communication being received within a predetermined time window or the communication originating from a particular application executed on the user equipment (e.g., a test application 228).

The user equipment 102 may be an example of a user equipment 102 as described in relation to FIG. 1 above. As noted elsewhere, a user equipment 102 may include any suitable electronic device configured to interact with a network.

Similar to the access node 126, a user equipment 102 may include one or more hardware processors 220 configured to execute stored instructions. Such processor(s) 220 may comprise one or more processing cores. Further, the user equipment 102 may include one or more communication interfaces 222 configured to provide communications between the user equipment 102 and other devices, such as a gateway device 122 or another suitable electronic device.

Similar to the access node 126, the user equipment 102 may also include computer-readable media 224 that stores various executable components (e.g., software-based components, firmware-based components, etc.). The computer-readable media 224 may store components to implement functionality described herein.

The computer-readable media 224 may include portions, or components, that configure the user equipment 102 to perform various operations described herein. For example, the computer-readable media 224 may include some combination of components configured to implement the described techniques. In embodiments, the computer-readable media 224 of the user equipment 102 may include one or more software application 226. In some cases, the user equipment 102 may include a test application 228 that is configured to perform functions and/or access information/updates associated with a particular environment or application server.

A software application 226 may be any suitable set of computer executable instructions that causes the user equipment to perform one or more functions. In embodiments, a software application 226 may be supported by a remote server. In other words, when executed, the software application may cause the user equipment 102 to communicate with a remote server to perform at least a portion of the functionality provided by the software application 226. The network traffic generated during such a communication may be transmitted to the gateway device 122 to be routed to its intended destination device.

In embodiments, the user equipment, upon execution of one or more software applications, is caused to establish communication with a cell service (CS) node 230. In order to do so, the user equipment 102 establishes a communication session between itself and the gateway device 122. The gateway device 122 may then route communications between the user equipment 102 (over the established communication session) and a access node 126 of an environment associated with the gateway device 122. The access node 126 may then determine which of the core nodes 230 (e.g., either 230 (1) or 230 (2)) should be used to process the communication. As noted elsewhere, one or more core node 230 (1) may be associated with the environment in which the access node 126 is implemented whereas one or more core node 230 (2) may be implemented within an environment that is separate from the environment in which the access node 126 is implemented.

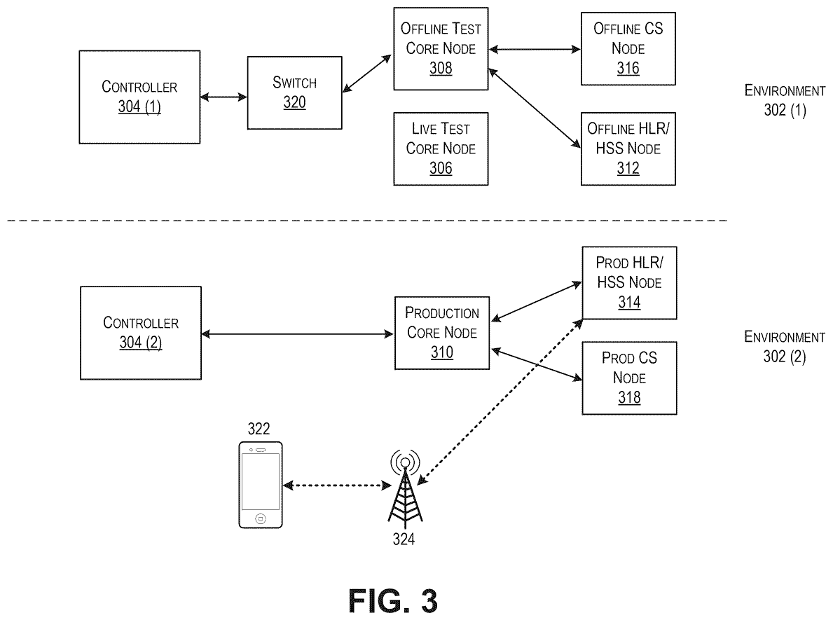

FIG. 3 depicts a block diagram illustrating a first set of interactions between multiple environments in accordance with at least some embodiments. More particularly, FIG. 3 depicts two environments (e.g., environment 302 (1) and environment 302 (2)) that are segregated (e.g., are not directly connected).

Each environment 302 (1 and 2) may include a controller device 304 (e.g., controller device 304 (1) and controller device 304 (2)) that manages/orchestrates functions within the respective environment. In embodiments, the controller device 304 may perform a highly scalable server role that provides a centralized, programmable point of automation to manage, configure, monitor, and troubleshoot the environment infrastructure. In embodiments, each controller may manage operations of a core node, such as a live test core node 306, an offline test core node 308, and/or a production core node 310.

A core node may include a number of computing device that perform the central functions of an environment. For example, a core node may include any suitable computing device that performs a service that is necessary to the operation of an environment. Each core node may be in communication with a Home Subscriber Server (HSS)/Home Subscriber Register (HLR) node (e.g., offline HLR/HSS node 312 or production HLR/HSS node 314) that serves as the primary database/repository of subscriber information for the environment. Additionally, each core node may be in communication with a cell service (CS) node (e.g., offline CS node 316 or production CS node 318) that manages a configuration (e.g., through parameters) of the environment as well as interactions between various components operating within the environment. For example, a CS node may manage handoffs between two different cells of the environment 302.

In embodiments, an environment 302 (1) may include a switch 320 that is configured to manage routing of communications to one of multiple core nodes. For example, the environment 302 (1) may include a switch 320 that routes communications to either an offline test core node 308 or a live test core node 306 depending on whether certain conditions have been met, such as which of the core nodes are currently active. In some cases, the switch 320 may route communications to a respective core node based on identifiers associated with the user equipment from which the respective communications originate. In such embodiments, the switch 320 may be a smart network switch that is equipped with configuration and management functions (e.g., a command line interface (CLI), a simple network management protocol (SNMP) agent, a web interface, etc.) that enable the switch 320 to be remotely configured to route data packet to specific network nodes based on various parameters, such as device identification information, data routing settings, network conditions, and/or so forth.

In the environment 302 (1) a switch 320 may be configured to run in an offline testing mode. In such cases, all communications received within the environment 302 (1) may be routed to an offline test core node 308. That offline test core node 308 may be configured to retrieve operating parameters/services from one or more of an offline HLR/HSS node 312 or an offline CS node 316. In such cases, the environment 302 (1) may remain completely segregated from the environment 302 (2) such that a user equipment operating within either environment is unable to access data/services available in the other environment.

In operation, a user equipment 322 in communication with a gateway device 324 (e.g., a base station) associated with the environment 302 (2) may interact only with components in the environment 302 (2) while the switch 320 is configured to run only offline testing. In such cases, communications originating at the user equipment 322 may be relayed by the gateway device 324 to a production HLR/HSS node 314. The production HLR/HSS node 314 makes a determination that the environment 302 (1) is not currently available (e.g., based on no current communication session between it and the environment 302 (1)) and relays all communications to the production core node 310, which then provides services to the user equipment 322 based on operating parameters/services available within the environment 302 (2).

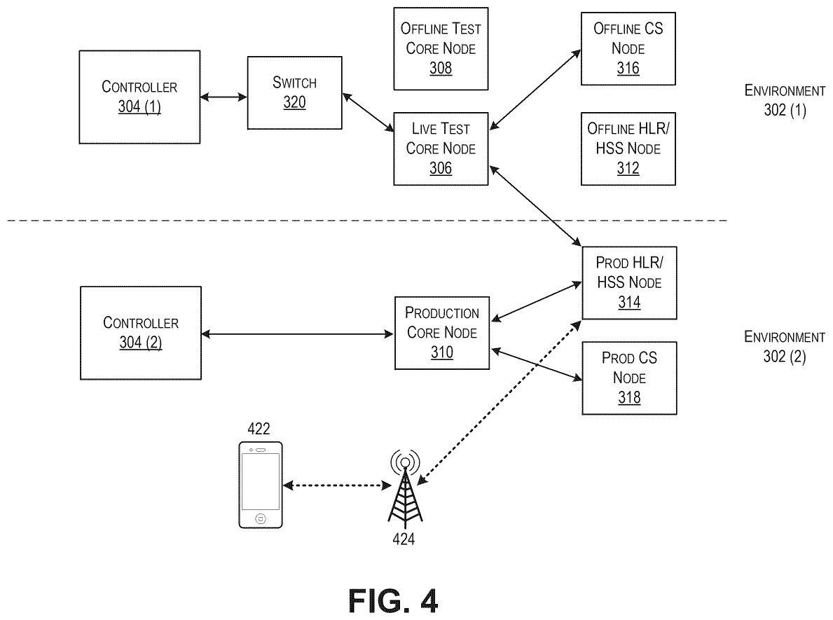

FIG. 4 depicts a block diagram illustrating a second set of interactions between multiple environments in accordance with at least some embodiments. Similar to FIG. 3 described above, FIG. 4 depicts two environments (e.g., environment 302 (1) and environment 302 (2)).

As noted above, an environment 302 (1) may include a switch 320 that routes communications to either an offline test core node 308 or a live test core node 306 depending on whether certain conditions have been met, such as which of the core nodes are currently active. In the environment 302 (1) of FIG. 4, the switch 320 may be configured to run in a live testing mode. In such cases, a live test core node 306 may be configured to retrieve operating parameters/services from an offline CS node 316 while communicating with a production HLR/HSS node 314. In such cases, an open communication session may be established between the live test core node 306 and the production HLR/HSS node 314 and the environment 302 (1) may be made accessible to user equipment operating within the environment 302 (2) or vice versa.

When the switch 320 implemented within the environment 302 (1) has been set to a live testing mode, the live test core node 306 may establish a communication session with the production HLR/HSS node 314. The live test core node 306 may provide the production HLR/HSS node 314 an indication that live testing is available through the environment 302 (1) over that communication session. In some cases, the live test core node 306 may provide information about one or more conditions that need to be satisfied to access the environment 302 (1). For example, the one or more conditions may include a list (or range) of user equipment identifiers that uniquely identify user equipment that is authorized to access the environment 302 (1). In another example, the one or more conditions may include an indication of dates/times within which live testing mode may be active. In yet another example, the one or more conditions may include an indication of a software application associated with the live testing.

In operation, a user equipment 422 in communication with a gateway device 424 (e.g., a base station) associated with the environment 302 (2) may send one or more communications to the production HLR/HSS node 314 of the environment 302 (2). In embodiments, the production HLR/HSS node 314 may act as an access node 126 as described in relation to FIG. 2 above. Accordingly, the production HLR/HSS node 314 may be configured to, upon receiving a communication from a user equipment 422, make a determination about which core node (e.g., 306 or 310) the communication should be routed to.

In embodiments, upon receiving a communication from a user equipment 422, the production HLR/HSS node 314 may determine which core node that communication should be sent to based on whether the communication meets the conditions indicated for live testing. For example, the production HLR/HSS node 314 may make a determination that the communication should be routed to the live testing core node 306 if it meets each of the conditions associated with the live testing mode. In this example, such a determination may be made if an identifier associated with the communication (e.g., an International Mobile Subscriber Identity (IMSI)) falls within a range of identifiers that are authorized to access the testing environment 302 (1), a time at which the communication is received is within a time during which the live testing mode is available, and/or the communication originates at a particular application or relates to a particular service.

Upon making a determination that the communication meets each of the conditions for accessing the testing environment 302 (1), the production HLR/HSS node 314 may route that communication to the live test core node 306. In such cases, the live test core node 306, when interacting with the user equipment 422, may use operating parameters/services implemented by the offline CS node 316. Additionally, the live test core node 306 may use information available on the production HLR/HSS node 314.

Upon making a determination that the communication does not meet each of the conditions for accessing the testing environment 302 (1), the production HLR/HSS node 314 may route that communication to the production core node 310. In such cases, the production core node 310, when interacting with the user equipment 422, may use operating parameters/services implemented by the production CS node 318.

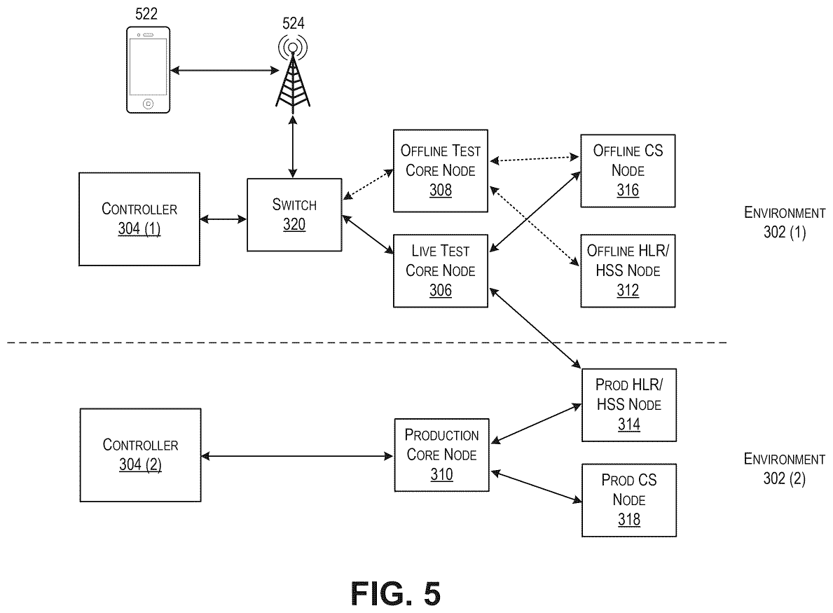

FIG. 5 depicts a block diagram illustrating a third set of interactions between multiple environments in accordance with at least some embodiments. Similar to FIG. 3 and FIG. 4 described above, FIG. 5 depicts two environments (e.g., environment 302 (1) and environment 302 (2)).

As noted above, an environment 302 (1) may include a switch 320 that routes communications to either an offline test core node 308 or a live test core node 306 depending on whether certain conditions have been met, such as which of the core nodes are currently active. Similar to FIG. 4 as described above, FIG. 5, the switch 320 may be configured to run in a live testing mode. In such cases, a live test core node 306 may be configured to retrieve operating parameters/services from an offline CS node 316 while communicating with a production HLR/HSS node 314. In such cases, an open communication session may be established between the live test core node 306 and the production HLR/HSS node 314 so that the environment 302 (2) may be made accessible to user equipment operating within the environment 302 (1) or vice versa.

As noted elsewhere, when the switch 320 implemented within the environment 302 (1) has been set to a live testing mode, the live test core node 306 may establish a communication session with the production HLR/HSS node 314. The live test core node 306 may provide the production HLR/HSS node 314 with an indication that live testing is available through the environment 302 (1) over that communication session.

In operation, a user equipment 522 in communication with a gateway device 524 (e.g., a base station) associated with the environment 302 (1) may send one or more communications to the switch 320 (or another suitable component operating within the environment 302 (1)) to be routed to one of multiple available core nodes implemented in that environment. Notably, the switch 320 may act as an access node 126 as described in relation to FIG. 2 above, in that it makes determinations about which core node received communications should be routed to.

In embodiments, the switch 320 may, upon receiving a communication, make a determination (e.g., based on whether the communication meets conditions as described elsewhere) as to whether the communication should be routed to a live test core node 306 or to an offline test core node 308.

As noted elsewhere, communications that meet each of the conditions for accessing live testing may be routed to the live test core node 306. In embodiments, the live test core node 306, when interacting with the user equipment 522, may use operating parameters/services implemented by the offline CS node 316 along with information available on a production HLR/HSS node 314 of a second environment 302 (2).

In contrast, communications that do not meet each of the conditions for accessing live testing may be routed to the offline test core node 308. In embodiments, the offline test core node 308, when interacting with the user equipment 522, may use operating parameters/services implemented by the offline CS node 316 along with information available on an offline HLR/HSS node 312.

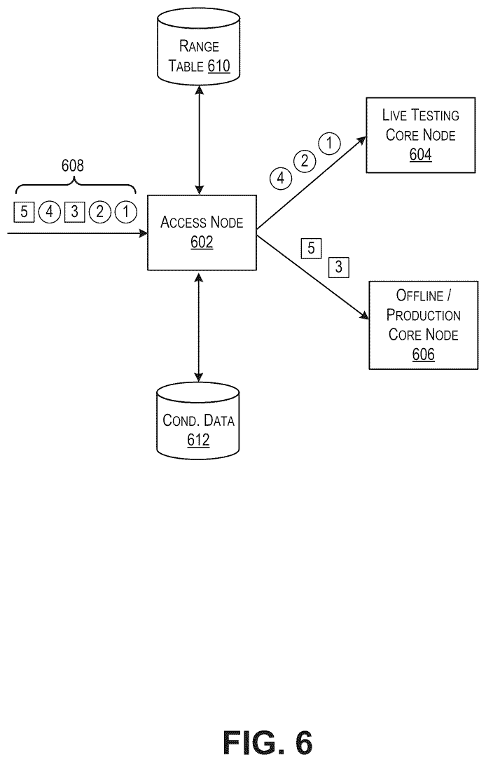

FIG. 6 depicts a block diagram illustrating a process for routing communications to various core nodes in accordance with embodiments. In embodiments, an access node 602 may be an example of the access node 126 as described in relation to FIG. 1 above. Note that such an access node 602 may be implemented within a HLR/HSS node (as illustrated in relation to FIG. 3 and FIG. 4 above) or within a switch (as illustrated in relation to FIG. 6 above).

In embodiments, the access node 602 may be in communication with, and manage routing of communications to, multiple core nodes. Each of the multiple core nodes may be implemented within the same environment that includes the access node 602 or may be implemented within an environment that is otherwise segregated from the environment that includes the access node 602. By way of example, the access node 602 may be in communication with a live testing core node 604 (which may be an example of the live testing core node 306 as described elsewhere) as well as a offline/production core node 606 (which may be an example of a offline test core node 308 or a production core node 310 as described elsewhere).

In embodiments, the access node 602 may receive a number of communications 608 that are received from various user equipment. In the depicted example, the access node 602 may make a determination about which of the core nodes (e.g., live testing core node 604 or offline/production core node 606). Such a determination may be made for each communication 508 based on whether the respective communication meets one or more conditions as described below.

In some embodiments, the access node 602 maintains information about specific unique identifiers or a range of unique identifiers that are authorized to access the live testing core node 604 (e.g., range table 610). For example, the access node 602 may maintain a database of IMSIs that correspond to user equipment that are authorized to access the live testing core node 604. In some cases, the range table 610 may include information about individual IMSIs that are authorized to access the live testing core node 604. In other cases, the range table 610 may include an indication of at least one range of IMSI values that are able to access the live testing core node 604. For example, a range of IMSI values may be formatted as ABCD123A-ABCD123Z, wherein any user equipment associated with an IMSI that falls within that indicated range is authorized to access the live testing core node 604. In embodiments, the access node 602 may determine that communications 508 that originate from a user equipment that has an IMSI that is included in the list (or falls within the indicated range of IMSI values) should be routed to the live testing core node 604, whereas other communications are determined to be routed to the offline/production core node 606.

In some embodiments, the access node 602 maintains information about other conditions that must be met by a communication in order to be provided access the live testing core node 604 (e.g., condition data 612). For example, the condition data 612 may include an indication of a range of times within which access to the live testing core node 604 is to be granted. In such an example, the access node 602 may route a communication 508 that is received outside of that range of times to the offline/production core node 606 even if the communication meets other conditions (e.g., an IMSI associated with the communication falls within a range indicated as authorized to access the live testing core node 604 within the range table 810). In another example, the condition data 612 may include an indication of a software application or service. In this example, communications originating from an indicated software application and/or directed to an indicated service may be routed to the live testing core node 604 whereas other communications are routed to the offline/production core node 606.

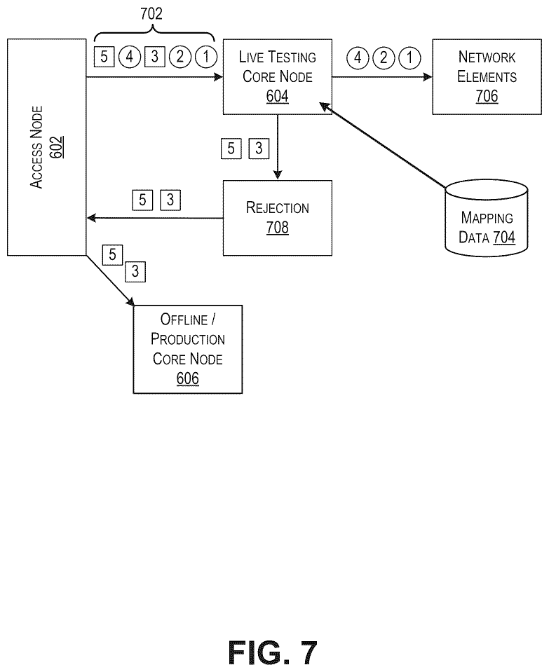

FIG. 7 depicts a block diagram illustrating a process for rejecting incorrectly received communications in accordance with embodiments. The process illustrated in FIG. 7 may be performed by a live testing core node 604 in order to reject communications that were erroneously received at the live testing core node 604.

As depicted in FIG. 7, a number of communications 702 may be routed to a live testing core node 604 by an access node 602. The access node 602 may be an example of the access node 602 described in FIG. 6. Likewise, the live testing core node 604 may be an example of the live testing core node 604 described in FIG. 6.

Upon receiving one or more of the communications 702, a live testing core node 604, before providing one or more functions that would typically be provided by a core node, may first verify that the communication 702 was not erroneously received. In embodiments, this may involve verifying that a second identifier associated with the communication is authorized to access the live testing core node 604. For example, while the access node 602 may initially make a determination as to whether the communication should be routed to the live testing core node 604 based on whether an IMSI associated with the user equipment that originated the communication is authorized, the live testing core node 604 may verify that a Mobile Station International Subscriber Directory Number (MSISDN) associated with the communication actually corresponds to the IMSI associated with the communication.

In embodiments, the live testing core node 604 may maintain mapping data 704 that includes mappings (e.g., correspondences) between unique identifiers, such as mappings between IMSI identifiers and MSISDN identifiers. Notably, while a user equipment may be associated with an IMSI (e.g., a serial number), the MSISDN is generally associated with the account for the service associated with that user equipment (e.g., via a SIM card, etc.). It should be noted that while directing communications to different core nodes based on IMSI may be beneficial, a bad actor may be able to circumvent this access control feature by using a user equipment having a cloned or fake IMSI that falls within an authorized range. Hence, a backup access control feature may be implemented by a core node (e.g., live testing core node 604) in which the core node verifies that the MSISDN corresponds to an IMSI that is authorized to access it.

Provided that the live testing core node 604 makes a determination (e.g., based on mapping data 704) that a communication 702 is authorized to access it, the live testing core node 604 may forward the communication 702 to one or more additional network elements 706 in order to provide services/functionality to the user equipment from which the respective communication originated. In contrast, if the live testing core node 604 makes a determination (e.g., based on mapping data 704) that a communication 702 is not authorized to access it, the live testing core node 604 may reject the respective communication at 708. In embodiments, this may involve routing the communication (or a message, such as an error message, related to the communication) back to the access node 602, so that the communication 702 can then be routed to an offline/production core node 606.

As would be recognized by one skilled in the art, the processes described in relation to FIG. 6 and FIG. 7, when implemented together or separately, can be used to prevent erroneous access to a core node of an environment, preventing issues that can arise from testing new updates from occurring in a production environment.

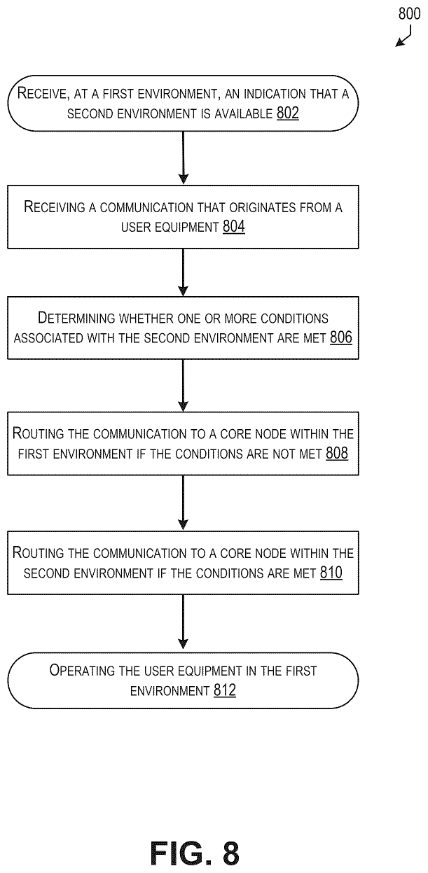

FIG. 8 depicts a flow diagram illustrating an exemplary process for generating tag assignment data to be used in network traffic allocation in accordance with at least some embodiments. The process 800 may be performed by a node device operating within a network (e.g., a cellular network), such as the access node 126 as described in relation to FIG. 1 above. The access node may be in communication with a user equipment to enable it to access services within the first environment or a second environment. In embodiments the first environment may be a production environment whereas the second environment is a testing environment. As noted elsewhere, the user equipment may be a mobile device that operates using a network connection, such as a cellular phone.

At 802, the process 800 may involve receiving an indication that a second environment is accessible. In embodiments, such an indication may be received from a core node implemented within the second environment. The indication that the second environment is accessible may include an indication of one or more conditions associated with accessing the second environment. In some embodiments, such conditions may include specific identifier or a range of identifiers associated with user equipment that are authorized to access the second environment. In some embodiments, such conditions may include at least a time period within which the second environment is accessible.

At 804, the process 800 may involve receiving a communication that originates from a user equipment. Such a communication may include a variety of information that relates to the communication itself and/or a user equipment from which the communication has originated. For example, the communication may include an indication of a unique identifier (e.g., an IMSI) associated with the user equipment that originated the communication.

At 806, the process may involve making a determination as to whether one or more conditions associated with accessing the second environment have been met in relation to the communication. As noted elsewhere, in some cases, this may involve determining whether a unique identifier associated with the user equipment is authorized to access the second environment. For example, the identifier may be IMSI and the access node may maintain a list of IMSIs that are authorized to access the second environment.

At 808, the process may involve routing the communication to a core node within the first environment if the conditions have not been met. It should be noted that in some instances, the communication is routed to the core node within the first environment even if that communication meets some of the conditions.

In some cases, communications may be routed to the core node within the first environment if it does not meet each of the conditions (e.g., it fails to meet at least one of the conditions). For example, if the communication is determined to have originated from a user equipment that is associated with an identifier that is granted authorization to access the second environment, but is received at a time that is outside of the time period during which access is to be granted, then the communication is forwarded to the core node within the first (e.g., production) environment.

At 810, the process may involve routing the communication to a core node within the second environment if the conditions have been met. In some cases, additional verification steps may be performed. For example, the second core node may then be caused to verify that an IMSI of the user equipment matches a MSISDN associated with that IMSI.

At 812, the process may involve operating the user equipment in the first environment. While the user equipment is operating in the first environment it may be caused to use one or more operating parameters and/or services associated with the second environment.

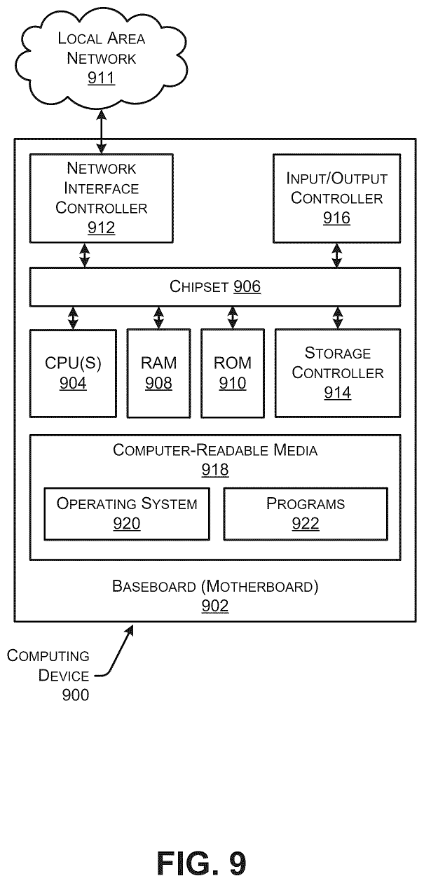

FIG. 9 shows an example computer architecture for a computing device 900 capable of executing program components for implementing the functionality described above. Such a computing device 900 may be implemented as user device (e.g., user equipment 102) or as network node (e.g., access node 126) as described herein. The computer architecture shown in FIG. 9 illustrates a conventional server computer, workstation, desktop computer, laptop, tablet, network appliance, e-reader, smartphone, or other computing device, and can be utilized to execute any of the software components presented herein. The computing device 900 may, in some examples, correspond to a physical server as described herein, and may comprise networked devices such as servers, switches, routers, hubs, bridges, gateways, modems, repeaters, access points, etc.

The computing device 900 includes a baseboard 902, or “motherboard,” which is a printed circuit board to which a multitude of components or devices can be connected by way of a system bus or other electrical communication paths. In one illustrative configuration, one or more central processing units (“CPUs”) referred to as processors 904 operate in conjunction with a chipset 906. The processors 904 can be standard programmable processors that perform arithmetic and logical operations necessary for the operation of the computing device 900.

The processors 904 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 906 provides an interface between the processors 904 and the remainder of the components and devices on the baseboard 902. The chipset 906 can provide an interface to a RAM 908, used as the main memory in the computing device 900. The chipset 906 can further provide an interface to a computer-readable storage medium such as a read-only memory (“ROM”) 910 or non-volatile RAM (“NVRAM”) for storing basic routines that help to startup the computing device 900 and to transfer information between the various components and devices. The ROM 910 or NVRAM can also store other software components necessary for the operation of the computing device 900 in accordance with the configurations described herein.

The computing device 900 can operate in a networked environment using logical connections to remote computing devices and computer systems through a network, such as the network 911. The chipset 906 can include functionality for providing network connectivity through a NIC 912, such as a gigabit Ethernet adapter. The NIC 912 is capable of connecting the computing device 900 to other computing devices over the network 911. It should be appreciated that multiple NICs 912 can be present in the computing device 900, connecting the computer to other types of networks and remote computer systems.

The computing device 900 can be connected to a storage device 918 that provides non-volatile storage for the computer. The storage device 918 can store an operating system 920, programs 922, and data, which have been described in greater detail herein. The storage device 918 can be connected to the computing device 900 through a storage controller 914 connected to the chipset 906. The storage device 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 900 can store data on the storage device 918 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 918 is characterized as primary or secondary storage, and the like.

For example, the computing device 900 can store information to the storage device 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 can further read information from the storage device 918 by detecting the physical states or characteristics of one or more particular locations within the physical storage units.

In addition to the mass storage device 918 described above, the computing device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 900. In some examples, the operations performed by devices as described herein may be supported by one or more devices similar to computing device 900. Stated otherwise, some or all of the operations performed by an edge device, and/or any components included therein, may be performed by one or more computing device 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 918 can store an operating system 920 utilized to control the operation of the computing device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 918 can store other system or application programs and data utilized by the computing device 900.

In one embodiment, the storage device 918 or other computer-readable storage media is encoded with computer-executable instructions which, when loaded into the computing device 900, transform the computer from a general-purpose computing system into a special-purpose computer capable of implementing the embodiments described herein. These computer-executable instructions transform the computing device 900 by specifying how the CPUs (e.g., processors 904) transition between states, as described above. According to one embodiment, the computing device 900 has access to computer-readable storage media storing computer-executable instructions which, when executed by the computing device 900, perform the various processes described above with regard to the other figures. The computing device 900 can also include computer-readable storage media having instructions stored thereupon for performing any of the other computer-implemented operations described herein.

The computing device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can provide output to a display, such as a computer monitor, a flat-panel display, a digital projector, a printer, or other type of output device. It will be appreciated that the computing device 900 might not include all of the components shown in FIG. 9, can include other components that are not explicitly shown in FIG. 9, or might utilize an architecture completely different than that shown in FIG. 9.

As described herein, the computing device 900 may include one or more hardware processors 904 (processors) configured to execute one or more stored instructions. The processors 904 may comprise one or more cores. Further, the computing device 900 may include one or more network interfaces configured to provide communications between the computing device 900 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 911. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 922 may comprise any type of programs or processes to perform the techniques described in this disclosure. The programs 922 may comprise any type of program that cause the computing device 900 to perform techniques for communicating with other devices using any type of protocol or standard usable for determining connectivity.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, one or more module executed on the computing device 900 may also include computer executable instructions that, when executed by processor(s), cause computing device 900 to perform the techniques described herein. To do so, in some embodiments, a module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, one or more module included on the computing device 900 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
receiving, at an access node implemented in a first environment, an indication that a second environment is accessible;
receiving, at the access node, a communication that originates from a user equipment;
determining, by the access node based on information about the communication, whether one or more conditions associated with a second environment are met;
upon determining, by the access node, that the one or more conditions are not met, routing the communication to a first core node implemented within the first environment; and
upon determining, by the access node, that the one or more conditions are met, routing the communication to a second core node implemented within the second environment, wherein the user equipment is caused to operate in the first environment using one or more operating parameters associated with the second environment.

2. The method of claim 1, wherein the information about the communication comprises at least an identifier associated with the user equipment.

3. The method of claim 1, wherein the indication that the second environment is accessible includes an indication of the one or more conditions associated with the second environment.

4. The method of claim 1, wherein the one or more conditions comprises at least a time period within which the second environment is accessible.

5. The method of claim 1, wherein determining whether one or more conditions associated with a second environment are met comprises determining whether a unique identifier associated with the user equipment is authorized to access the second environment.

6. The method of claim 5, wherein the identifier comprises an International Mobile Subscriber Identity (IMSI) identifier.

7. The method of claim 6, wherein the second core node is caused to verify that the IMSI matches a Mobile Station International Subscriber Directory Number (MSISDN) associated with the IMSI.

8. The method of claim 1, wherein the first environment comprises a production environment.

9. The method of claim 1, wherein the second environment comprises a testing environment.

10. An access node implemented in a first environment comprising:
one or more processors; and
one or more non-transitory computer-readable media storing computer-executable instructions that, when executed by the one or more processors, cause the access node to perform operations comprising:
receiving an indication that a second environment is accessible;
receiving a communication that originates from a user equipment;
determining, based on information about the communication, whether one or more conditions associated with a second environment are met;
upon determining that the one or more conditions are not met, routing the communication to a first core node implemented within the first environment; and
upon determining that the one or more conditions are met, routing the communication to a second core node implemented within the second environment, wherein the user equipment is caused to operate in the first environment using one or more operating parameters associated with the second environment.

11. The access node of claim 10, wherein the information about the communication comprises at least an identifier associated with the user equipment.

12. The access node of claim 10, wherein the indication that the second environment is accessible includes an indication of the one or more conditions associated with the second environment.

13. The access node of claim 10, wherein the one or more conditions comprises at least a time period within which the second environment is accessible.

14. The access node of claim 10, wherein determining whether one or more conditions associated with a second environment are met comprises determining whether a unique identifier associated with the user equipment is authorized to access the second environment.

15. The access node of claim 14, wherein the identifier comprises an International Mobile Subscriber Identity (IMSI) identifier.

16. The access node of claim 15, wherein the second core node is caused to verify that the IMSI matches a Mobile Station International Subscriber Directory Number (MSISDN) associated with the IMSI.

17. A system comprising:
a first core node implemented within a first environment;
a second core node implemented within a second environment different from the first environment;
an access node implemented within the first environment, the access node configured to:
receive a communication from one or more user equipment operating in the first environment;
determine, based on information associated with an individual user equipment of the one or more user equipment, whether the communication meets one or more conditions associated with the second environment;
upon making a determination that the communication meets the one or more conditions, route the communication to the second core node; and
upon making a determination that the communication does not meet the one or more conditions, route the communication to the first core node.

18. The system of claim 17, wherein the communication meets at least one of the one or more conditions associated with the second environment if the communication relates to a specified software application or specified service.

19. The system of claim 17, wherein the second core node comprises a live testing core node configured to enable testing of software updates and services.

20. The system of claim 19, wherein the one or more user equipment in communication with the second core node is caused to operate using operating parameters associated with the first environment while accessing the software updates or services.
